(19) United States
(12) Patent Application Publication
(10) Pub. No.: US 2012/0285427 A1
(43) Pub. Date: Nov. 15, 2012

(54) EXHAUST MANIFOLD ASSEMBLY WITH INTEGRATED EXHAUST GAS RECIRCULATION BYPASS

(75) Inventors: Alan W. Hayman, Romeo, MI (US); Rodney E. Baker, Fenton, MI (US)

(73) Assignee: GM GLOBAL TECHNOLOGY OPERATIONS LLC, Detroit, MI (US)

(21) Appl. No.: 13/104,545

(22) Filed: May 10, 2011

(51) Int. Cl. F02M 25/07

(52) U.S. Cl. 123/568.11

(57) ABSTRACT

An exhaust manifold assembly includes a first manifold member and a second manifold member. The first manifold member includes a first group of runners joining to define an exhaust treatment outlet, and a second group of runners. The second manifold member includes a primary passage and an inlet runner in fluid communication with each runner of the second group of runners and the primary passage. A bypass control valve opens fluid communication between the primary passage of the second manifold member and the exhaust treatment outlet to allow the internal combustion engine to operate in a normal mode where all exhaust gas is discharged through the exhaust treatment outlet, and closes fluid communication between the primary passage of the second manifold member and the exhaust treatment outlet to direct exhaust gas from the second group of runners to an intake manifold to establish a dedicated EGR system.

### TECHNICAL FIELD

The invention generally relates to an exhaust system for an internal combustion engine of a vehicle, and more specifically to a manifold assembly for selectively recirculating exhaust gas from dedicated EGR cylinders of the internal combustion engine to an intake manifold.

### BACKGROUND

Internal combustion engines may re-circulate exhaust gas from one or more dedicated cylinders to an intake manifold, typically referred to as Exhaust Gas Recirculation (EGR), to improve fuel efficiency of the vehicle and/or reduce engine emissions. When the exhaust gas from a pre-determined number of the cylinders of the internal combustion engine is dedicated to the intake manifold for EGR purposes, the maximum power output of the internal combustion engine is reduced.

### SUMMARY

An exhaust manifold assembly for an internal combustion engine is provided. The exhaust manifold assembly includes a first manifold member and a second manifold member. The first manifold member defines a plurality of runners, with each runner configured for receiving exhaust gas from a respective cylinder of the internal combustion engine. The plurality of runners includes a first group of runners and a second group of runners. Each of the first group of runners joins together to define an exhaust treatment outlet. Each of the second group of runners terminates at an outlet. The first manifold member defines a bypass passage in fluid communication with at least one runner of the first group of runners. The second manifold member is attached to the first manifold member. The second manifold member includes a primary passage and an inlet runner disposed adjacent to and in fluid communication with the outlet of each of the second group of runners. Each of the inlet runners is in fluid communication with the primary passage. The primary passage defines an EGR outlet, and is in fluid communication with the bypass passage. A bypass control valve interconnects the primary passage and the bypass passage. The bypass control valve is moveable between an open position and a closed position. When in the open position, the bypass control valve opens fluid communication between the primary passage and the bypass passage to allow exhaust gas to flow from the second group of runners to the first group of runners and out the exhaust treatment exit. When in the closed position, the bypass control valve closes fluid communication between the primary passage and the bypass passage to direct exhaust gas from the second group of runners out the EGR outlet.

An exhaust system for an internal combustion engine of a vehicle is also provided. The exhaust system includes a first manifold member and a second manifold member. The first manifold member defines a plurality of runners, with each runner configured for receiving exhaust gas from a respective cylinder of the internal combustion engine. The plurality of runners includes a first group of runners and a second group of runners. Each of the first group of runners joins together to define an exhaust treatment outlet. Each of the second group of runners terminates at an outlet. The first manifold member defines a bypass passage in fluid communication with at least one runner of the first group of runners. The second manifold member is attached to the first manifold member. The second manifold member includes a primary passage and an inlet runner disposed adjacent to and in fluid communication with the outlet of each of the second group of runners. Each of the inlet runners is in fluid communication with the primary passage. The primary passage defines an EGR outlet and is in fluid communication with the bypass passage. The bypass passage defines a bypass flange. The outlets of each runner of the second group of runners defines an outlet flange. The bypass flange and the outlet flange of each of the outlets of the second group of runners are disposed in a co-planar relationship. A bypass control valve interconnects the primary passage and the bypass passage. The bypass control valve is moveable between an open position and a closed position. When in the open position, the bypass control valve opens fluid communication between the primary passage and the bypass passage to allow exhaust gas to flow from the second group of runners to the first group of runners and out the exhaust treatment exit. When in the closed position, the bypass control valve closes fluid communication between the primary passage and the bypass passage to direct exhaust gas from the second group of runners out the EGR outlet. An EGR passage is attached to the second manifold member and in fluid communication with the EGR outlet. The EGR passage is configured for directing exhaust gas to an intake manifold.

Accordingly, the manifold assembly allows the internal combustion engine to operate in either a normal mode or in a dedicated Exhaust Gas Recirculation (EGR) mode. When operating in the normal mode, the exhaust from all cylinders of the internal combustion engine is directed to the exhaust treatment outlet for treatment and discharge into the ambient air. When operating in the dedicated EGR mode, the exhaust from the second group of runners is directed to the intake manifold for EGR purposes, thereby improving fuel efficiency and reducing engine emissions. When the bypass control valve is disposed in the open position, the internal combustion engine operates in the normal mode, and when the bypass control valve is disposed in the closed position, the internal combustion engine operates in the dedicated EGR mode.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of an exhaust system for an internal combustion engine of a vehicle.

FIG. 2 is a schematic perspective view of an exhaust manifold assembly of the exhaust system.

FIG. 3 is a schematic perspective view of a first manifold member of the manifold assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

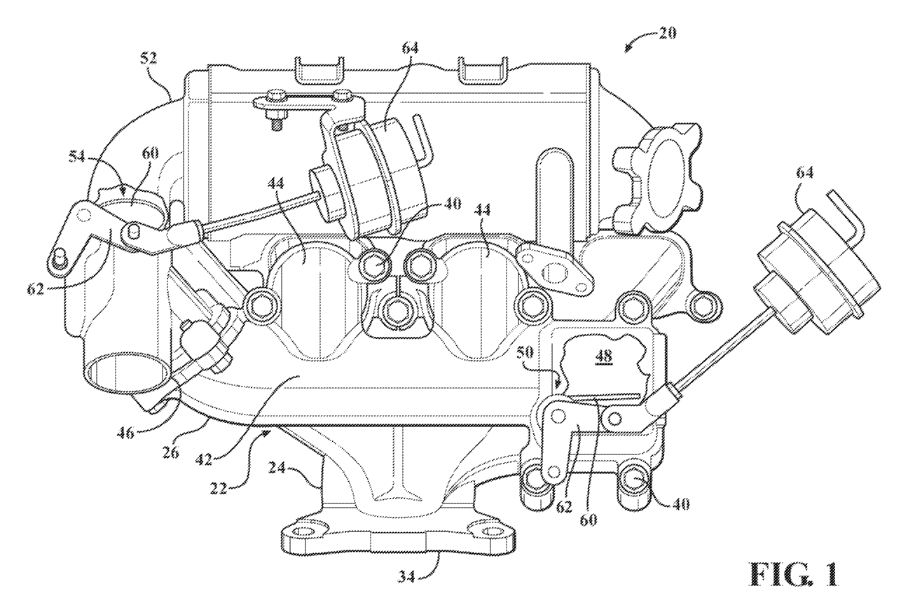

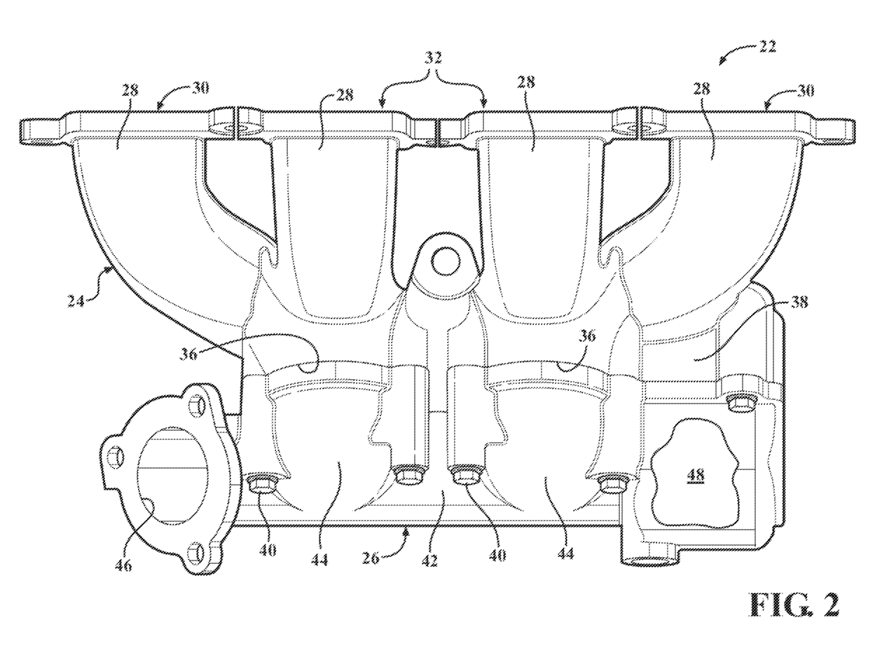

Referring to the Figures, wherein like numerals indicate like parts throughout the several views, an exhaust system is generally shown at 20 in FIG. 1. The exhaust system 20 includes an exhaust manifold assembly 22, shown in FIG. 2, for an internal combustion engine (not shown). The internal combustion engine is for a vehicle, and may include but is not limited to a diesel engine or a gasoline engine. As shown in the Figures, the exhaust system 20 and the exhaust manifold assembly 22 are configured for an in-line four cylinder engine. However, it should be appreciated that the internal combustion engine may include any suitable size and/or configuration of engine, including but not limited to an in-line six cylinder engine, a v-style six cylinder engine, or a v-style eight cylinder engine.

The exhaust manifold assembly 22 is configured for attachment to a cylinder head assembly (not shown), which is attached to an engine block (not shown). As is known, the block defines a plurality of cylinders. The cylinder head assembly defines a plurality of exhaust ports, with one of the exhaust ports in fluid communication with one of the cylinders of the block for discharging exhaust gas after combustion.

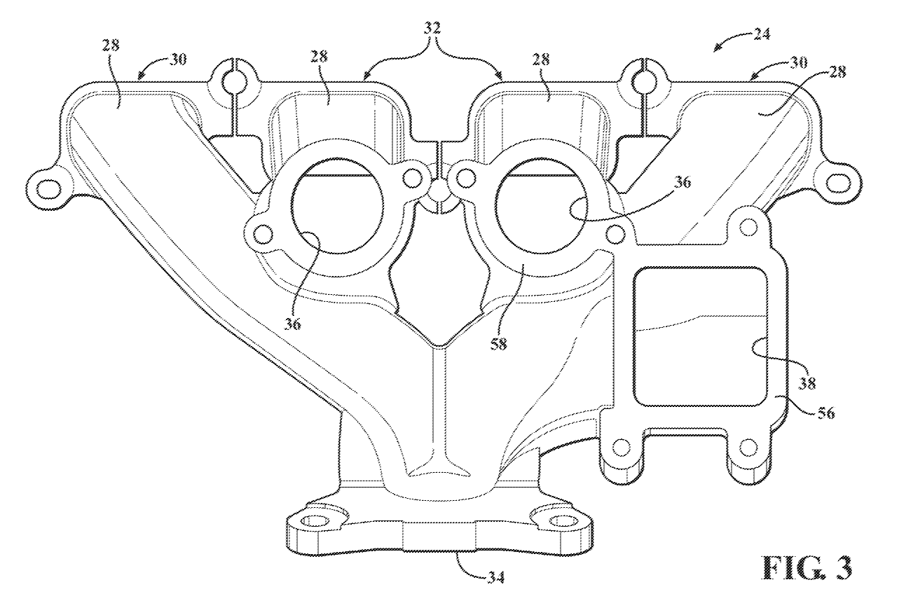

Referring to FIGS. 2 and 3, the exhaust manifold assembly 22 includes a first manifold member 24 and a second manifold member 26. The first manifold member 24 defines a plurality of runners 28, with each runner 28 configured for receiving exhaust gas from one cylinder of the internal combustion engine. The plurality of runners 28 includes a first group of runners 30 and a second group of runners 32. The first group of runners 30 includes a pre-defined number of runners 28, and the second group of runners 32 includes a pre-defined number of runners 28. Preferably, the pre-defined number of runners 28 of the first group of runners 30 is equal to the pre-defined number of runners 28 of the second group runners 28. The pre-defined number of runners 28 of the first group of runners 30 is equal to two (2), and the pre-defined number of runners 28 of the second group of runners 32 is equal to two (2). However, it should be appreciated that the pre-defined number of runners 28 of the first group of runners 30 may differ from the pre-defined number of runners 28 of the second group of runners 32. For example, the first group of runners 30 may include three (3) runners 28, and the second group of runners 32 may include one (1) runner.

As shown in FIGS. 1 and 3, each runner of the first group of runners 30 joins together to define an exhaust treatment outlet 34. The exhaust treatment outlet 34 is in fluid communication with an exhaust treatment system (not shown). The exhaust treatment system treats the exhaust gas from the internal combustion engine to reduce and/or eliminate harmful emissions from the exhaust gas as is known prior to being discharged into the air. Each runner of the second group of runners 32 terminates at an outlet 36, and are not directly in fluid communication with the exhaust treatment outlet 34 defined by the first manifold member 24.

Referring to FIG. 3, the first manifold member 24 further defines a bypass passage 38. The bypass passage 38 is in fluid communication with at least one runner of the first group of runners 30 and/or the exhaust treatment outlet 34. The bypass passage 38 interconnects the second manifold member 26 and the first manifold member 24 in fluid communication.

Referring to FIGS. 1 and 2, the second manifold member 26 is attached to the first manifold member 24. The second manifold member 26 may be attached to the first manifold member 24 in any suitable manner. For example and as shown, a plurality of fasteners 40 may connect the second manifold member 26 to the first manifold member 24.

The second manifold member 26 includes a primary passage 42 and an inlet runner 44 disposed adjacent and in fluid communication with the outlet 36 of each of the second group of runners 32. Each of the inlet runners 44 is in fluid communication with the primary passage 42. Accordingly, exhaust gas from the second group of runners 32 flows into the primary passage 42. The primary passage 42 defines an Exhaust Gas Recirculation (EGR) outlet 46 at a first end, and defines a valve chamber 48 at an opposite end of the primary passage 42. The valve chamber 48 is in fluid communication with the bypass passage 38 of the first manifold member 24.

Referring to FIG. 1, a bypass control valve 50 is disposed within the valve chamber 48 defined by the primary passage 42. The bypass control valve 50 interconnects the primary passage 42 and the bypass passage 38 in fluid communication. The bypass control valve 50 is moveable between an open position and a closed position. The bypass control valve 50 opens fluid communication between the primary passage 42 and the bypass passage 38 when in the open position. When in the open position, the bypass control valve 50 allows exhaust gas to flow from the second group of runners 32, through the primary passage 42, to the first group of runners 30 and out the exhaust treatment exit. The bypass control valve 50 closes fluid communication between the primary passage 42 and the bypass passage 38 when in the closed position. When in the closed position, the bypass control valve 50 directs exhaust gas from the second group of runners 32 out the EGR outlet 46 of the second manifold member 26.

An EGR passage 52 is attached to the second manifold member 26, and is in fluid communication with the EGR outlet 46. The EGR passage 52 is configured for directing exhaust gas to an intake manifold (not shown) to establish a dedicated EGR system. When the internal combustion engine is operating in the dedicated EGR system, up to one hundred percent (100%) of the exhaust gas from the second group of runners 32, and thereby from the cylinders of the internal combustion engine in fluid communication with the second group of runners 32, may be provided to the intake manifold to reduce emissions of the internal combustion engine and increase fuel efficiency.

As shown in FIG. 1, the dedicated EGR system may further include an EGR control valve 54. The EGR control valve 54 is disposed within the EGR passage 52, and is moveable between an open position and a closed position. When in the open position, the EGR control valve 54 is configured to open fluid communication through the EGR passage 52 to allow a flow of exhaust gas through the EGR passage 52. When in the closed position, the EGR control valve 54 is configured to close fluid communication through the EGR passage 52 to block the flow of exhaust gas through the EGR passage 52.

The EGR control valve 54 works in cooperation with the bypass control valve 50 to control the flow of exhaust gas through the exhaust system 20. Accordingly, the EGR control valve 54 is disposed in the open position when the bypass valve is disposed in the closed position. The bypass control valve 50 is disposed in the closed position to force exhaust gas through the EGR passage 52 to establish the dedicated EGR system. The EGR control valve 54 is open to allow the exhaust gas to flow therethrough. In order to operate the internal combustion engine in a normal operating mode, whereby all exhaust gas from both the first group of runners 30 and the second group of runners 32 is directed through the exhaust treatment outlet 34, the EGR control valve 54 is disposed in the closed position and the bypass control valve 50 is disposed in the open position. The bypass control valve 50 is open to allow exhaust gas to flow from the primary passage 42 into the bypass passage 38, and the EGR control valve 54 is closed to prevent the exhaust gas from flowing through the EGR passage 52 and into the intake manifold, thereby forcing the exhaust gas through the bypass control valve 50, into the first group of runners 30, and out the exhaust treatment outlet 34.

The bypass control valve 50 may include a variable intermediate position. The variable intermediate position may include any position of the bypass control valve 50 disposed between the open position and the closed position of the bypass control valve 50. The variable intermediate position is adjustable to regulate a flow of exhaust gas between both the bypass passage 38 and the EGR bypass passage 38. Accordingly, if the bypass control valve 50 is positioned in the intermediate position, a portion of the exhaust gas from the second group of runners 32 is directed into the bypass passage 38, while the remainder of the exhaust gas from the second group of runners 32 is directed through the EGR passage 52 to establish the dedicated EGR system. The amount of exhaust gas from the second group of runners 32 directed between the bypass passage 38 and the EGR passage 52 is adjustable by changing the position of the bypass control valve 50, i.e., by adjusting the variable intermediate position.

Referring to FIG. 3, the bypass passage 38 defines a bypass flange 56, and the outlets 36 of each runner 28 of the second group of runners 32 define an outlet flange 58. The bypass flange 56 and the outlet flange 58 of each of the outlets 36 of the second group of runners 32 may be disposed in a co-planar relationship, i.e., are disposed on the same plane. This orientation allows for the first manifold member 24 and the second manifold member 26 to be easily cast using known casting processes.

Referring to FIG. 1, the bypass control valve 50 includes a flapper 60 rotatably mounted to the second manifold member 26. The flapper 60 is rotatable about a rotation axis to define the open position and the closed position of the bypass control valve 50. A lever 62 is coupled to the flapper 60 to rotate the flapper 60 about the rotation axis. An actuator 64 is coupled to the lever 62. The actuator 64 moves the lever 62 to control, i.e., rotate, the flapper 60 between the open position and the closed position. The actuator 64 may include any suitable type and/or style of actuator 64, including but not limited to a vacuum actuator 64, a hydraulic actuator 64, or an electric actuator 64. The actuator 64 provides a liner movement to the lever 62 that is offset from the rotation axis, thereby causing the lever 62 to rotate about the rotation axis, which in turn rotates the flapper 60. The EGR control valve 54 may include the same components, i.e., a flapper 60, a lever 62 and an actuator 64, and may operate in the same manner as the bypass control valve 50 described above. It should be appreciated that the bypass control valve 50 and the EGR control valve 54 may each include some other type and/or style of valve not shown or described herein that is capable of opening and closing fluid communication between the primary passage 42 and the bypass passage 38, and between through the EGR passage 52 respectively.

While the best modes for carrying out the invention have been described in detail, those familiar with the art to which this invention relates will recognize various alternative designs and embodiments for practicing the invention within the scope of the appended claims.

1. An exhaust manifold assembly for an internal combustion engine, the exhaust manifold assembly comprising:
a first manifold member defining a plurality of runners, with each runner configured for receiving exhaust gas from a respective cylinder of the internal combustion engine;
wherein the plurality of runners includes a first group of runners and a second group of runners;
wherein each of the first group of runners joins together to define an exhaust treatment outlet;
wherein each of the second group of runners terminates at an outlet;
wherein the first manifold member defines a bypass passage in fluid communication with at least one runner of the first group of runners;
a second manifold member attached to the first manifold member and including a primary passage and an inlet runner disposed adjacent to and in fluid communication with the outlet of each of the second group of runners;
wherein each of the inlet runners is in fluid communication with the primary passage;
wherein the primary passage defines an EGR outlet and is in fluid communication with the bypass passage; and
a bypass control valve interconnecting the primary passage and the bypass passage and moveable between an open position and a closed position, wherein the bypass control valve opens fluid communication between the primary passage and the bypass passage when in the open position to allow exhaust gas to flow from the second group of runners to the first group of runners and out the exhaust treatment exit, and wherein the bypass control valve closes fluid communication between the primary passage and the bypass passage when in the closed position to direct exhaust gas from the second group of runners out the EGR outlet.

2. An exhaust manifold assembly as set forth in claim 1 wherein the bypass passage defines a bypass flange, and wherein the outlets of each runner of the second group of runners define an outlet flange, with the bypass flange and the outlet flange of each of the outlets of the second group of runners disposed in a co-planar relationship.

3. An exhaust manifold assembly as set forth in claim 1 further including an EGR passage attached to the second manifold member and in fluid communication with the EGR outlet, wherein the EGR passage is configured for directing exhaust gas to an intake manifold.

4. An exhaust manifold assembly as set forth in claim 3 further comprising an EGR control valve disposed within the EGR passage and moveable between an open position and a closed position, wherein the EGR control valve opens fluid communication through the EGR passage when in the open position, and wherein the EGR control valve closes fluid communication through the EGR passage when in the closed position.

5. An exhaust manifold assembly as set forth in claim 4 wherein the EGR control valve is disposed in the open position when the bypass control valve is disposed in the closed position, and wherein the EGR control valve is disposed in the closed position when the bypass control valve is disposed in the open position.

6. An exhaust manifold assembly as set forth in claim 3 wherein the bypass control valve includes a variable intermediate position disposed between the open position and the closed position of the bypass control valve, wherein the variable intermediate position is adjustable to regulate a flow of exhaust gas between both the bypass passage and the EGR passage.

7. An exhaust manifold assembly as set forth in claim 1 wherein the bypass control valve includes a flapper disposed within the primary passage and rotatable about a rotation axis to define the open position and the closed position of the bypass control valve.

8. An exhaust manifold assembly as set forth in claim 7 further comprising a lever coupled to the flapper and configured for rotating the flapper about the rotation axis.

9. An exhaust manifold assembly as set forth in claim 8 further comprising an actuator coupled to the lever and configured for moving the lever to control the flapper.

10. An exhaust manifold assembly as set forth in claim 1 wherein the first group of runners includes a pre-defined number of runners, and the second group of runners includes a pre-defined number of runners, with the pre-defined number of runners of the first group of runners equal to the pre-defined number of runners of the second group runners.

11. An exhaust manifold assembly as set forth in claim 10 wherein the pre-defined number of runners of the first group of runners is equal to two (2), and the pre-defined number of runners of the second group of runners is equal to two (2).

12. An exhaust manifold assembly as set forth in claim 1 further comprising a plurality of fasteners connecting the second manifold member to the first manifold member.

13. An exhaust system for an internal combustion engine of a vehicle, the exhaust system comprising:
a first manifold member defining a plurality of runners, with each runner configured for receiving exhaust gas from a respective cylinder of the internal combustion engine;
wherein the plurality of runners includes a first group of runners and a second group of runners;
wherein each of the first group of runners joins together to define an exhaust treatment outlet;
wherein each of the second group of runners terminates at an outlet;
wherein the first manifold member defines a bypass passage in fluid communication with at least one runner of the first group of runners;
a second manifold member attached to the first manifold member and including a primary passage and an inlet runner disposed adjacent to and in fluid communication with the outlet of each of the second group of runners;
wherein each of the inlet runners is in fluid communication with the primary passage;
wherein the primary passage defines an EGR outlet and is in fluid communication with the bypass passage;
wherein the bypass passage defines a bypass flange, and wherein the outlets of each runner of the second group of runners define an outlet flange, with the bypass flange and the outlet flange of each of the outlets of the second group of runners disposed in a co-planar relationship;
a bypass control valve interconnecting the primary passage and the bypass passage and moveable between an open position and a closed position, wherein the bypass control valve opens fluid communication between the primary passage and the bypass passage when in the open position to allow exhaust gas to flow from the second group of runners to the first group of runners and out the exhaust treatment exit, and wherein the bypass control valve closes fluid communication between the primary passage and the bypass passage when in the closed position to direct exhaust gas from the second group of runners out the EGR outlet; and
an EGR passage attached to the second manifold member and in fluid communication with the EGR outlet, wherein the EGR passage is configured for directing exhaust gas to an intake manifold.

14. An exhaust system as set forth in claim 13 further comprising an EGR control valve disposed within the EGR passage and moveable between an open position and a closed position, wherein the EGR control valve opens fluid communication through the EGR passage when in the open position, and wherein the EGR control valve closes fluid communication through the EGR passage when in the closed position.

15. An exhaust system as set forth in claim 14 wherein the EGR control valve is disposed in the open position when the bypass control valve is disposed in the closed position, and wherein the EGR control valve is disposed in the closed position when the bypass control valve is disposed in the open position.

16. An exhaust system as set forth in claim 13 wherein the bypass control valve includes a variable intermediate position disposed between the open position and the closed position of the bypass control valve, wherein the variable intermediate position is adjustable to regulate a flow of exhaust gas between both the bypass passage and the EGR passage.

17. An exhaust system as set forth in claim 13 wherein the first group of runners includes a pre-defined number of runners, and the second group of runners includes a pre-defined number of runners, with the pre-defined number of runners of the first group of runners equal to the pre-defined number of runners of the second group runners.

18. An exhaust system as set forth in claim 17 wherein the pre-defined number of runners of the first group of runners is equal to two (2), and the pre-defined number of runners of the second group of runners is equal to two (2).
